(19) United States
(12) Patent Application Publication
(10) Pub. No.: US 2008/0066593 A1
(43) Pub. Date: Mar. 20, 2008

(54) Lathe chuck/faceplate holder

(76) Inventor: Gregory Teter, W. Chester, PA (US)

Correspondence Address: JAMES RAY & ASSOCIATES, 2640 PITCAIRN ROAD, MONROEVILLE, PA, 15146, US

(21) Appl. No.: 11/512,928

(22) Filed: Aug. 30, 2006

(51) Int. Cl. B23B 3/36

(52) U.S. Cl. 82/152

(57) ABSTRACT

An apparatus for use with the chuck of a lathe. The apparatus comprises an angled holder having a first predetermined shape and made of a first predetermined material and a faceplate engageable with the holder, the faceplate has a second predetermined shape and is formed of a second predetermined material. There are, further, bolts for securing the faceplate to the angled holder and another bolt for securing such chuck to the faceplate.

### FIELD OF THE INVENTION

The present invention relates, in general, to a holder for a lathe, and, more particularly, the present invention relates to a chuck/faceplate holder for use with a lathe.

### BACKGROUND OF THE INVENTION

A lathe is a machine that shapes material by spinning it rapidly while pressing it against a fixed cutting tool. The item being worked on must be secured firmly so that the cuttings are precise and the item can be shaped as desired. Some items are difficult to on particularly if they have an odd shape.

Also, sometimes it is not possible to use a lathe to drill through lamp turnings, for example, or deep vessels. In addition, a round piece is difficult to hold or clamp. Using a large Forstner bit to start hollowing is easier on a drill press. Clamping to a bandsaw to cut straight is also very complicated.

Thus, it would be advantageous for those people using a lathe, particularly for odd shaped pieces, if there were some means for securing the item to be worked on so that it would sit up straight (or perpendicular to the blade).

### SUMMARY OF THE INVENTION

The present invention provides an apparatus for use with the chuck of a lathe. The apparatus comprises an angled holder having a first predetermined shape and made of a first predetermined material and a faceplate engageable with the holder, the faceplate has a second predetermined shape and is formed of a second predetermined material. There is, further, a first means for securing the faceplate to the angled holder and a second means for securing such chuck to the faceplate.

### OBJECTS OF THE INVENTION

It is, therefore, one of the primary objects of the present invention to provide an apparatus for holding oddly sized or shaped lathe turnings (bowls, vases, lamps etc) in order to clamp to a drill press.

Another object of the present invention is to provide an apparatus for holding oddly sized or shaped lathe turnings (bowls, vases, lamps etc) in order to clamp to a band saw.

Still another object of the present invention is to provide an apparatus for holding other non-lathe irregular, round or oddly sized or shaped pieces.

Yet another object of the present invention is to provide a an apparatus that is relatively inexpensive.

It is still another object of the present invention to provide an apparatus for these irregular or round pieces that is relatively simple to use.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the angled holder of the apparatus with the necessary attachment means according to an embodiment of the invention.

FIG. 2 is a perspective view of the faceplate of the apparatus according to an embodiment of the invention.

FIG. 3 is a perspective view of the angled holder and the faceplate connected together as they would be used.

FIG. 4 is a perspective view of the apparatus with a chuck of a lathe and an article to be worked on attached to the chuck.

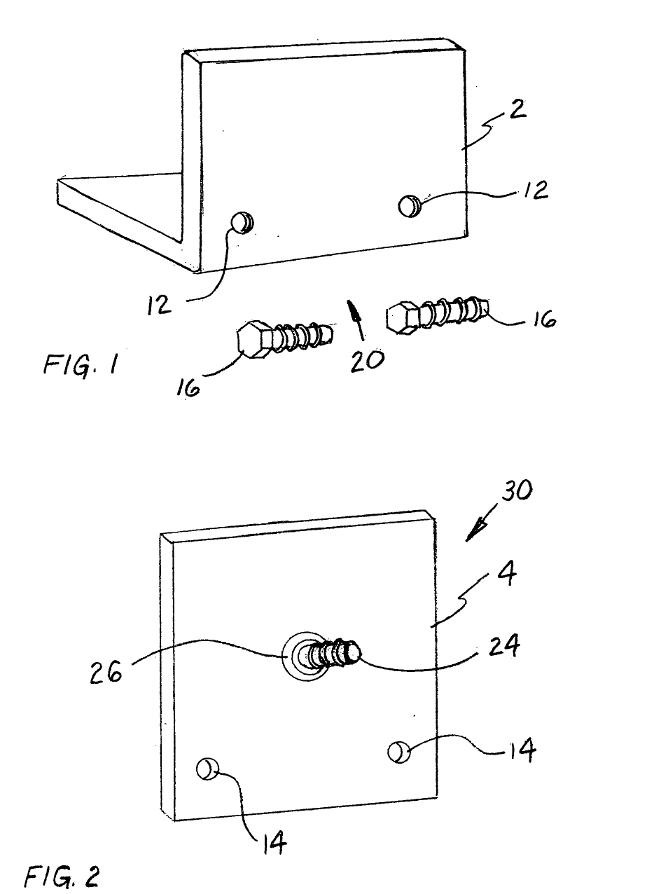

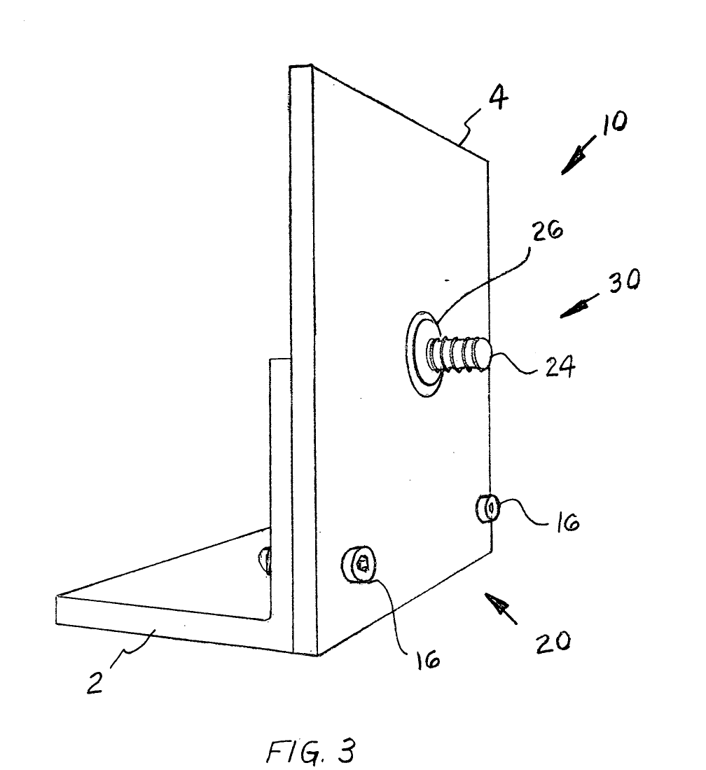

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides an apparatus, generally designated 10, for use with the chuck 6 of a lathe. The apparatus 10 comprises an angled holder 2 having a first predetermined shape and made of a first predetermined material and a faceplate 4 that is engageable with the holder 2. The faceplate 4 has a second predetermined shape and is formed of a second predetermined material. There is, further, a first means, generally designated 20, for securing the faceplate 4 to the angled holder 2 and a second means, generally designated 30, for securing such chuck 6 to the faceplate 4.

Such angled holder 2 further includes a pair of apertures 12 formed in the angled holder 2 at predetermined locations. The faceplate 4 also includes a pair of apertures 14 formed therein so as to be in alignment with the pair of apertures 12 formed in the angled holder 2.

Such first means 20 for securing the faceplate 4 to the angled holder 2 is a threaded means. It is presently preferred that such threaded means 20 is a bolt 16 or in this case a pair of bolts 16.

The faceplate 4 further includes an aperture 22 that is formed therein at substantially a midpoint of the faceplate 4. Such second means 30 for securing such chuck 6 to the faceplate 4 includes a threaded means for engagement with aperture 22 that is formed in substantially a midpoint of the faceplate 4. It is presently preferred that such threaded means 30 is a bolt 24. There is a rounded washer 26 for mounting on the bolt 24 for ease of removal of such chuck 6.

Such second predetermined shape of the faceplate 4 is substantially rectangular and it is preferred that the rectangle is substantially a square. It is preferred that each side of the substantially square faceplate is between about 7.5 and about 8.5 inches in length and even more preferred that each side of the substantially square faceplate is between about 7¾ and about 8¼ inches in length.

The first predetermined shape of the angled holder 2 is substantially a right angle bracket. It is preferred that right angle bracket 2 be between about 7½ inches and about 8½ inches in length and that each side of right angle bracket 2 is between about 2¾ and about 3¼ inches wide.

It is also preferred that such first predetermined material is metal and even more preferred that such metal is steel and also that the second predetermined material be the same as the first predetermined material.

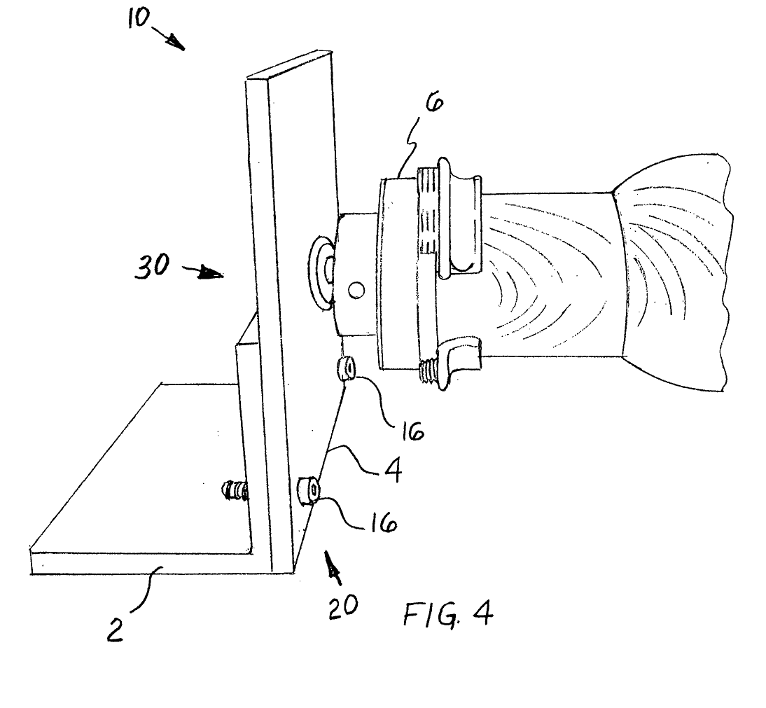

Thus, the present invention provides an apparatus 10 that is able to securely hold round or irregular shaped pieces to be worked on as is clearly evident in FIG. 4 where an odd shaped item is secured to the apparatus 10 ready for attachment to the lathe. The apparatus 10 enables the worker to easily shape work pieces by gripping and securely holding the turning in place while it s off the lathe. The simple device is an inexpensive yet invaluable as in any workshop.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for use with a chuck of a lathe, said apparatus comprising:
(a) an angled holder having a first predetermined shape and made of a first predetermined material;
(b) a faceplate engageable with said holder, said faceplate having a second predetermined shape and formed of a second predetermined material;
(c) a first means for securing said faceplate to said holder; and
(d) a second means for securing such chuck to said faceplate.

2. The apparatus, according to claim 1, wherein said angled holder further includes a pair of apertures formed in said angled holder at predetermined locations.

3. The apparatus, according to claim 2, wherein said face plate further includes a pair of apertures formed therein so as to be in alignment with said pair of apertures formed in said angled holder.

4. The apparatus, according to claim 3, wherein said first means is a threaded means.

5. The apparatus, according to claim 4, wherein said threaded means is a bolt.

6. The apparatus, according to claim 1, wherein said wherein said face plate further includes an aperture formed therein at substantially a midpoint of said face plate.

7. The apparatus, according to claim 6, wherein said second means includes a threaded means for engagement with said aperture formed in said substantially a midpoint of said faceplate.

8. The apparatus, according to claim 7, wherein said threaded means is a bolt.

9. The apparatus, according to claim 7, wherein said threaded means is further engageable with such chuck for securing such chuck to said faceplate.

10. The apparatus, according to claim 8, wherein said second means further includes a rounded washer for mounting on said bolt for ease of removal of such chuck.

11. The apparatus, according to claim 1, wherein said second predetermined shape of said faceplate is substantially square.

12. The apparatus, according to claim 6, wherein each side of said substantially square faceplate is between about 7.5 and about 8.5 inches in length.

13. The apparatus, according to claim 12, wherein each side of said substantially square faceplate is between about 7¾ and about 8¼ inches in length.

14. The apparatus, according to claim 1, wherein said first predetermined shape of said angled holder is substantially a right angle bracket.

15. The apparatus, according to claim 1, wherein said first predetermined material is metal.

16. The apparatus, according to claim 15, wherein said metal is steel.

17. The apparatus, according to claim 15, wherein said second predetermined material is similar to said first predetermined material.

18. The apparatus, according to claim 14, wherein said right angle bracket is between about 7½ inches and about 8½ inches in length.

19. The apparatus, according to claim 14, wherein each side of said right angle bracket is between about 2¾ and about 3¼ inches wide.
